(19) United States
(12) Patent Application Publication
(10) Pub. No.: US 2012/0285335 A1
(43) Pub. Date: Nov. 15, 2012

(54) AIRCRAFT GALLEY

(75) Inventors: Craig CUNNINGHAM, Old Northants (GB); Sebastien A. RAMUS, Olathe, KS (US); Sebastian PETRY, Seattle, WA (US); Christopher I. PIRIE, Mukilteo, WA (US); Michiel BLAAUWHOF, Haarlem (NL)

(73) Assignee: BE Aerospace, Inc., Wellington, FL (US)

(21) Appl. No.: 13/432,965

(22) Filed: Mar. 28, 2012

Related U.S. Application Data
(60) Provisional application No. 61/471,065, filed on Apr. 1, 2011.

(51) Int. Cl. A47J 31/00; B01F 3/04

(52) U.S. Cl. 99/323.1; 99/323.3

(57) ABSTRACT

An aircraft galley includes a beverage center including one or more hot beverage makers, and one or more combination oven-chiller units for multiple replaceable meal carrier rotables. The beverage center may also include an espresso maker, a milk frothing device, a hot water dispenser, a pull out drip tray, drain pan or sink, and a control panel. The aircraft galley also includes a main work deck with a sliding, pull-out work deck portion, and may include one or more pull-out combination drain-sink drawers including one or more individual drain-sinks.

### CROSS-REFERENCES TO RELATED APPLICATIONS

This application is based upon and claims priority from U.S. Provisional Application No. 61/471,065, filed Apr. 1, 2011, incorporated by reference in its entirety.

### BACKGROUND OF THE INVENTION

This invention generally relates to passenger aircraft galley systems, and more particularly relates to an aircraft galley including a beverage center and an oven-chiller combination for heating or cool storage of multiple rotables for food and beverages.

Aircraft galley systems for modern transport aircraft incorporate self-contained refrigeration units which are cooled to prevent spoilage of food prior to distribution to passengers, and to keep beverages at desired serving temperatures. These self-contained refrigeration units have in the past been interfaced with cold air supply systems in the galley designed to cool the interiors of the self-contained refrigeration units. Conventional galley refrigeration systems typically utilize self-contained air chillers which provide the cooled air directly to the food carts or refrigerated compartments. Such air chillers are typically installed above, below or otherwise within close proximity of the galley, and deliver cooled air via air ducts.

Such aircraft galley systems also commonly contain separate ovens for heating food in the preparation of hot meals to be served aboard aircraft. Currently space must be allocated for each of the heating and cooling devices separately, either in the same galley or in different galleys.

With the advent of long-range flights and larger passenger loads, the demand for more food and beverages on aircraft has dramatically increased. The need to provide multiple meals on very long flights has required extensive food chilling compartments. Also, because of the length of flights, more hot meals are being served, requiring more oven space. Conventional aircraft galley systems typically require separation of refrigerated spaces from oven spaces in aircraft, and multiple ovens and chillers, requiring duplication of controllers, heating elements, structural components, and the like.

It would be desirable to provide an aircraft galley system offering both hot and cold food and beverage service that overcomes these shortcomings, and conserves space and weight in aircraft, by including one or more combination oven-chiller units, each configured to receive multiple rotables of meal-trays, for heating of food and cooling of food and beverages. It would also be desirable for the one or more combination oven-chiller units to form a structural part of the aircraft galley. It would also be desirable to provide an aircraft galley system including a pull-out drain/sink, and a pull-out work deck integrated into the structure of the aircraft galley and sealing against liquid ingress. The present invention satisfies these and other needs.

### SUMMARY OF THE INVENTION

Briefly and in general terms, the present invention provides for an aircraft galley, including a beverage center, and one or more combination oven-chiller units, each typically having a heating mode for heating food items, and a refrigerator mode for cooling food and beverage items. In a presently preferred aspect, the beverage center includes one or more coffee or hot beverage makers configured to receive one or more corresponding coffee or beverage server containers, such as three coffee or hot beverage maker portions configured to receive up to three corresponding coffee or beverage server containers, for example. In another presently preferred aspect, the beverage center may also include an espresso maker, a milk frothing device, a hot water dispenser, a pull out drip tray, drain pan or sink, and a control panel for controlling the operation of one or more of the one or more coffee or hot beverage makers, espresso maker, milk frothing device and hot water dispenser. The beverage center typically may also include an upper cup shelf or storage area, which may also include an upper cup retaining bar for restraining beverage cups from falling out of the upper cup shelf or storage area.

In another presently preferred aspect, each combination oven-chiller unit is configured to receive multiple replaceable meal carrier components or rotables of meal-trays, typically with sideways rotation of meal-trays, for heating of food and cooling of food and beverages.

In another presently preferred aspect, the aircraft galley also includes a main work deck or work table with a sliding, pull-out work deck portion that is structurally integrated into the aircraft galley unit and that includes a sealed connection to the main work table or work deck, and the entire pull-out work deck portion is preferably slidably removable from the main work table or work deck area.

In another presently preferred aspect, the aircraft galley may also include one or more pull-out combination drain-sink drawers including one or more individual drain-sinks In another presently preferred aspect, the aircraft galley may also include one or more side accessory shelves, one or more wine or other alcoholic beverage cupboards, an upper cupboards or stowage area, and a lower cupboards or stowage area.

Other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a front elevational view of a first embodiment of the aircraft galley of the present invention.

FIG. 2 is an enlarged view of the beverage center portion of the aircraft galley of FIG. 1.

FIG. 3 is a front perspective view of the aircraft galley of FIG. 1, illustrating the sliding work deck.

FIG. 4 is a front perspective view of the aircraft galley of FIG. 1, illustrating a pull-out drain pan.

FIG. 5 is an enlarged view of a variation of the aircraft galley of FIG. 1, including an upper cup retaining bar.

FIG. 6 is an enlarged view of a variation of the aircraft galley of FIG. 1, including an additional side oven/chiller.

FIG. 7 is an enlarged view of the side oven configured to receive multiple meal carrier rotables of the aircraft galley of FIG. 1.

FIG. 8 is a front perspective view of the aircraft galley of FIG. 1, illustrating a pull-out drain/sink drawer.

FIG. 9 is a front elevational view of a second embodiment of the aircraft galley of the present invention.

FIG. 10 is an enlarged view of a beverage center portion of the aircraft galley of FIG. 9.

FIG. 11 is another enlarged view of a beverage center portion of the aircraft galley of FIG. 9, illustrating placement of beverage brewers.

### DETAILED DESCRIPTION OF THE PREFERRED EMBODIMENTS

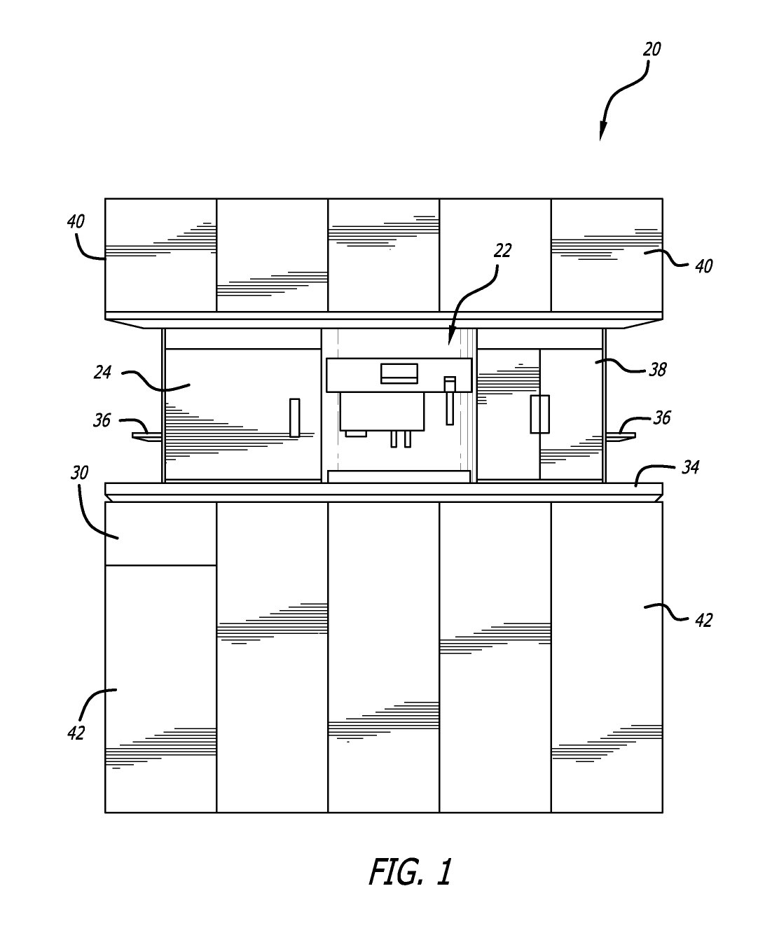

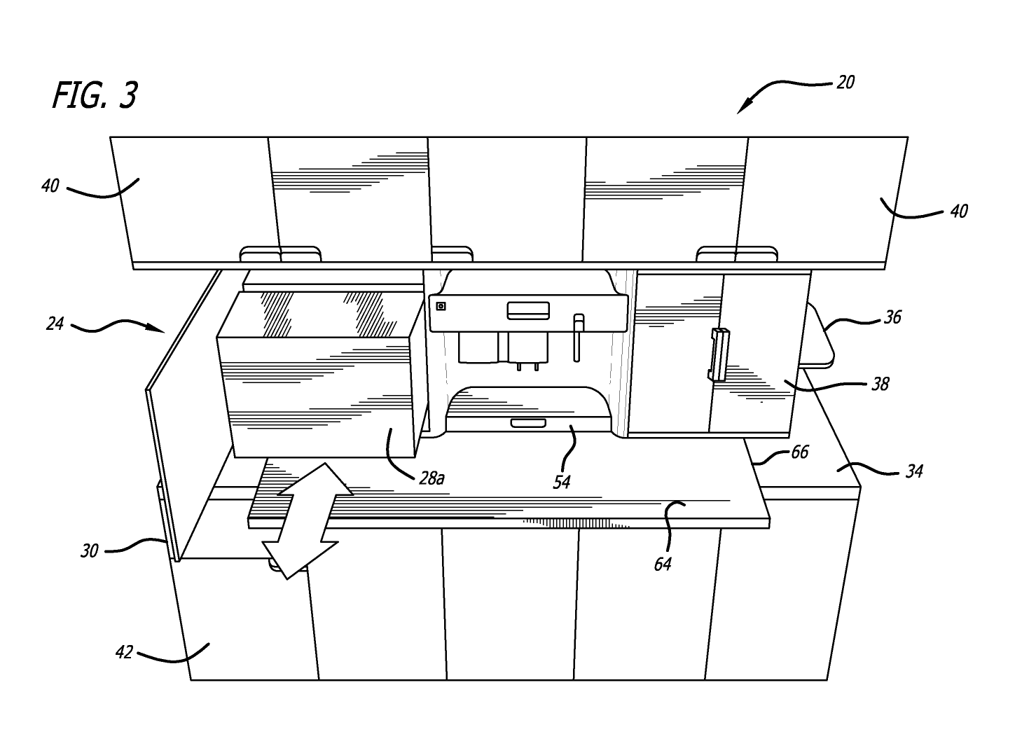

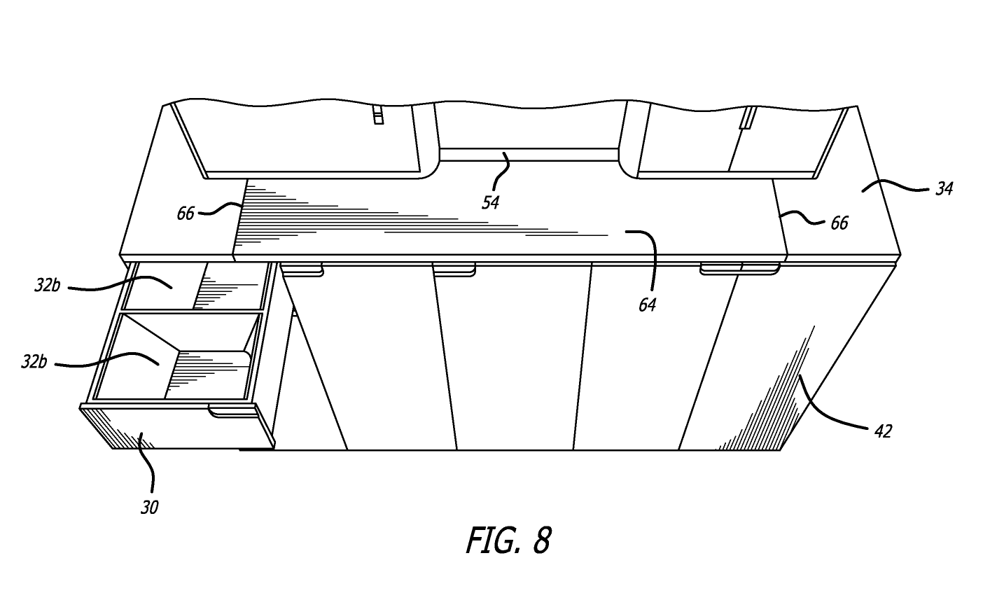

Referring to the drawings, which are provided by way of example, and not by way of limitation, the present invention provides for an aircraft galley 20 including a beverage center 22, one or more combination oven-chiller units, such as the oven-chiller units 24 and 26 illustrated in FIGS. 1 and 6, for example. In a presently preferred aspect, the combination oven-chiller units typically have a heating mode for heating food items, and a refrigerator mode for cooling food and beverage items, and may be of the type disclosed in U.S. Pat. No. 7,721,797, which is incorporated herein by reference. Such a combination oven-chiller unit typically includes a housing defining a thermally insulated compartment, a heating device disposed in the thermally insulated compartment for heating at least a portion of an interior of the compartment, and a refrigeration device disposed in the thermally insulated housing for cooling at least a portion of the interior of the compartment. As is illustrated in FIGS. 3 and 7, in another presently preferred aspect, each combination oven-chiller unit is configured to receive multiple replaceable meal carrier components or rotables 28a, 28b, 28c of meal-trays, typically with sideways rotation of meal-trays, for heating of food and cooling of food and beverages.

Referring to FIG. 1, in a presently preferred aspect, the aircraft galley of the present invention also typically includes at least one pull-out combination drain-sink drawer 30 that provides one or more individual drain-sinks 32a, 32b, illustrated in FIG. 8, and a main work deck or work table 34. In another presently preferred aspect, the aircraft galley may also include one or more side accessory shelves 36, and typically includes one or more wine or other alcoholic beverage cupboards 38, an upper cupboards or stowage area 40, and a lower cupboards or stowage area 42.

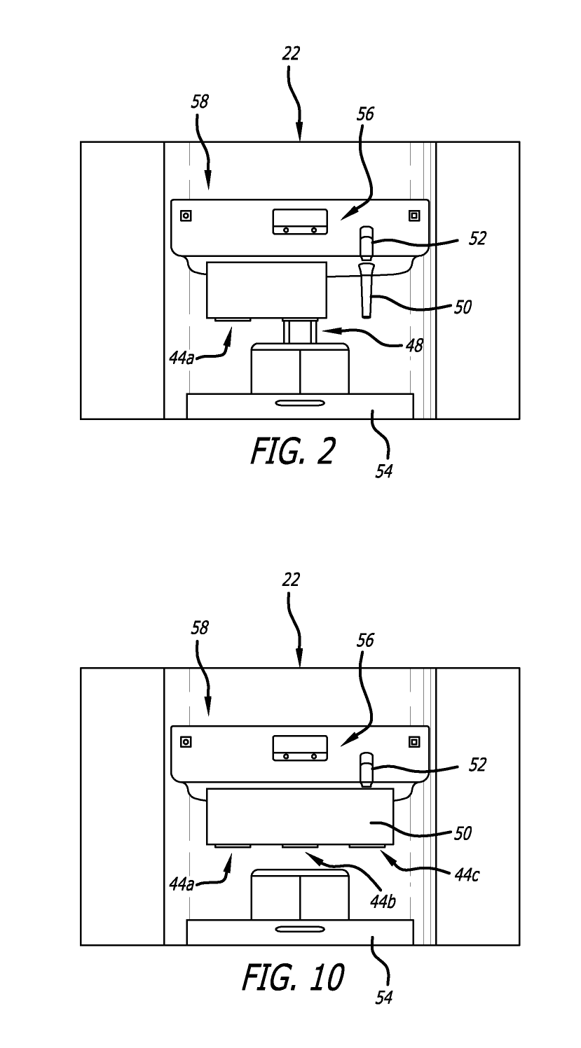

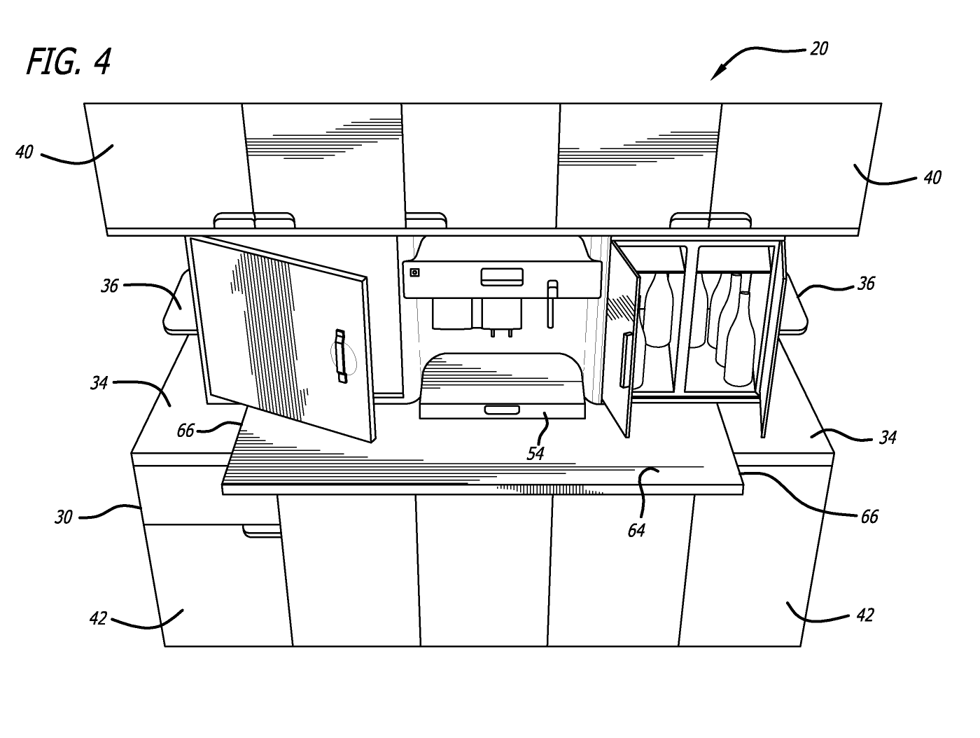

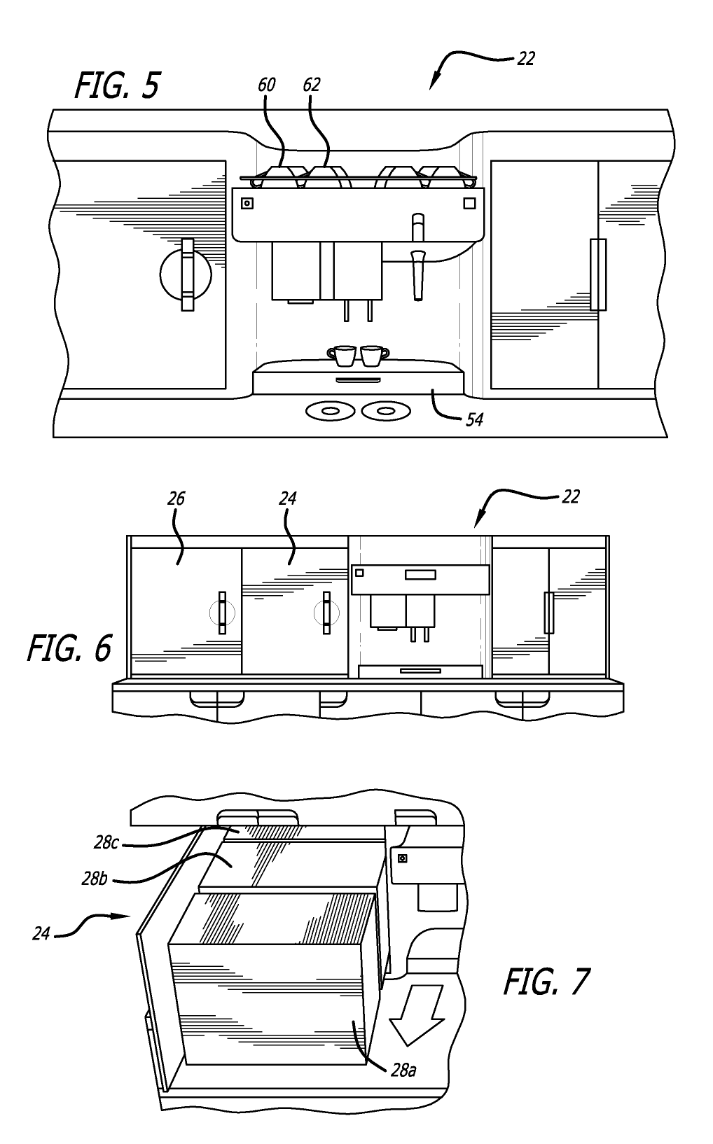

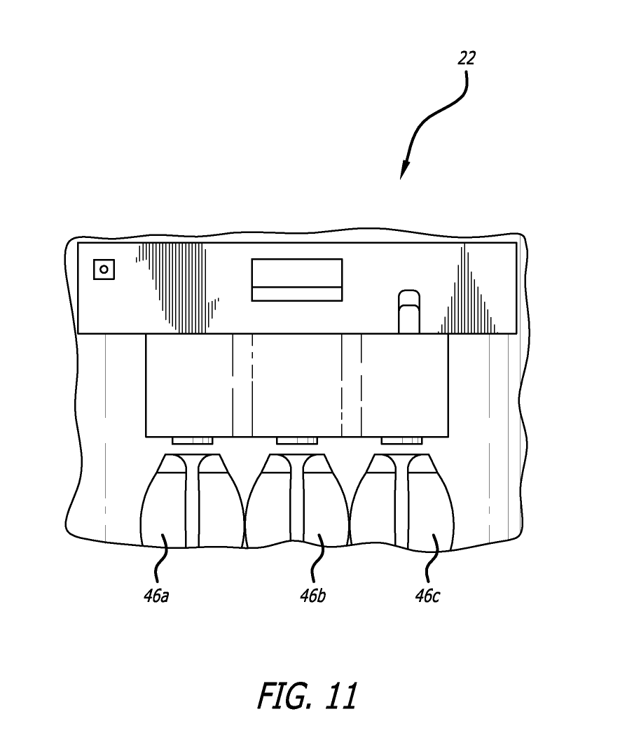

As is illustrated in FIG. 2, the beverage center portion of the aircraft galley typically includes one or more coffee or hot beverage makers 44a configured to receive one or more corresponding coffee or beverage server containers 46a, illustrated in FIG. 11. In another presently preferred aspect the beverage center portion of the aircraft galley also includes an espresso maker 48, a milk frothing device 50, a hot water dispenser 52, and a pull out drip tray, drain pan or sink 54, which is also illustrated as partially removed in FIG. 4. The beverage center portion of the aircraft galley also includes a control panel 56 for controlling the operation of one or more of the one or more coffee or hot beverage makers, espresso maker, milk frothing device and hot water dispenser. The beverage center portion of the aircraft galley may also include an upper cup shelf or storage area 58. As is illustrated in FIG. 5, in one presently preferred variation of the aircraft galley, the upper cup shelf or storage area may also include an upper cup retaining bar 60 for restraining beverage cups 62 from falling out of the upper cup shelf or storage area.

In another presently preferred aspect, the aircraft galley typically includes a sliding, pull-out work deck portion 64 that is structurally integrated into the aircraft galley unit, such as by tongue and groove slidable, sealed connection to the main work table or work deck 34 at side edges 66, for example, with the entire pull-out work deck portion being slidably removable from the main work table or work deck area. The sliding, sealed connection of the pull-out work deck portion to the main work table or work deck provides both for structural attachment of the pull-out work deck portion to the main work table or work deck and a seal against liquid ingress. Independent structural attachments to the aircraft are required for other portions of the aircraft galley.

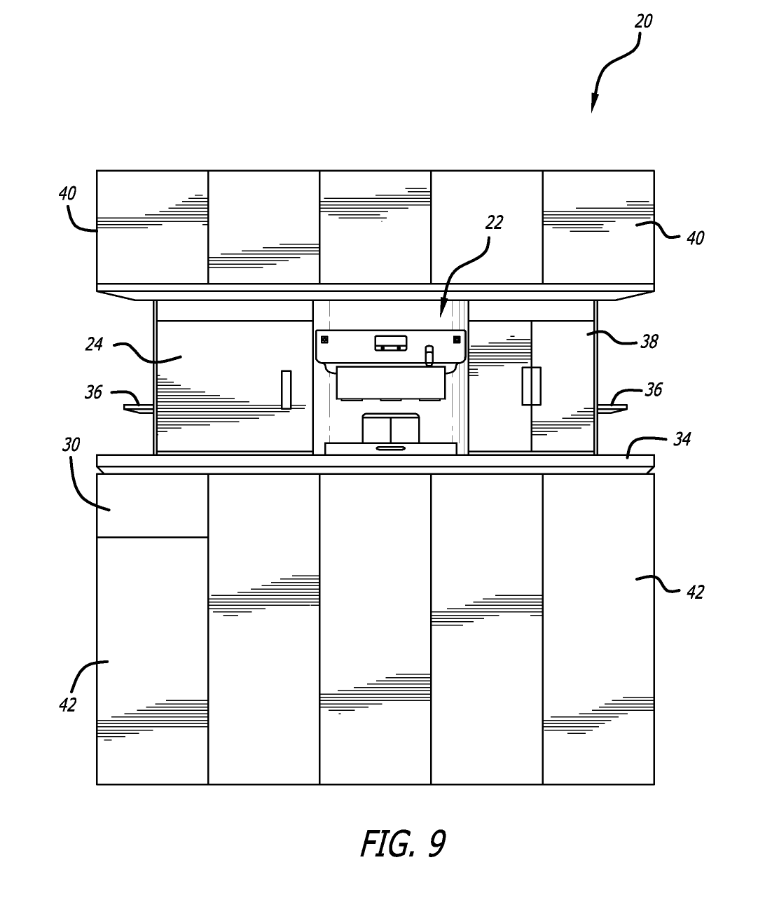

Referring to FIGS. 9 and 10, in a second embodiment of the aircraft galley of the present invention, the beverage center portion of the aircraft galley typically includes three coffee or hot beverage maker portions 44a, 44b, 44c configured to receive up to three corresponding coffee or beverage server containers 46a, 46b, 46c, illustrated in FIG. 11. In another presently preferred aspect the beverage center portion of the aircraft galley also includes a hot water dispenser 52, and a pull out drip tray, drain pan or sink 54. The beverage center portion of the aircraft galley also includes a control panel 56 for controlling the operation of one or more of the coffee or hot beverage makers, and hot water dispenser. The beverage center portion of the aircraft galley may also include an upper cup shelf or storage area 58, which may also include an upper cup retaining bar for restraining beverage cups from falling out of the upper cup shelf or storage area.

It will be apparent from the foregoing that while particular forms of the invention have been illustrated and described, various modifications can be made without departing from the spirit and scope of the invention. Accordingly, it is not intended that the invention be limited, except as by the appended claims.

We claim:

1. An aircraft galley, comprising:
a beverage center including at least one hot beverage maker configured to receive at least one corresponding beverage server container; and
at least one combination oven-chiller unit connected to said beverage center, each said at least one combination oven-chiller unit having a heating mode for heating food items, and a refrigerator mode for cooling food and beverage items, each said at least one combination oven-chiller unit being configured to receive a plurality of replaceable meal carrier rotables.

2. The aircraft galley of claim 1, wherein said beverage center includes an espresso maker.

3. The aircraft galley of claim 2, wherein said beverage center includes a milk frothing device,

4. The aircraft galley of claim 1, wherein said beverage center includes a pull out drip tray.

5. The aircraft galley of claim 3, wherein said beverage center includes a control panel for controlling the operation of at least one of said at least one hot beverage maker, said espresso maker, and said milk frothing device.

6. The aircraft galley of claim 1, further comprising a main work deck connected to said beverage center and said at least one combination oven-chiller unit, said main work deck including a sliding, pull-out work deck portion that is structurally integrated into the aircraft galley and that includes a sealed connection to the main work deck.

7. The aircraft galley of claim 6, wherein said pull-out work deck portion is slidably removable from said main work deck.

8. The aircraft galley of claim 1, further comprising at least one pull-out combination drain-sink drawer including at least one drain-sink.

9. An aircraft galley, comprising:
a beverage center including at least one hot beverage maker configured to receive at least one corresponding beverage server container;
at least one combination oven-chiller unit connected to said beverage center, each said at least one combination oven-chiller unit having a heating mode for heating food items, and a refrigerator mode for cooling food and beverage items, each said at least one combination oven-chiller unit being configured to receive a plurality of replaceable meal carrier rotables; and
a main work deck connected to said beverage center and said at least one combination oven-chiller unit, said main work deck including a sliding, pull-out work deck portion that is structurally integrated into the aircraft galley and that includes a sealed connection to the main work deck.

10. The aircraft galley of claim 9, wherein said beverage center includes an espresso maker.

11. The aircraft galley of claim 10, wherein said beverage center includes a milk frothing device,

12. The aircraft galley of claim 9, wherein said beverage center includes a pull out drip tray.

13. The aircraft galley of claim 11, wherein said beverage center includes a control panel for controlling the operation of at least one of said at least one hot beverage maker, said espresso maker, and said milk frothing device.

14. The aircraft galley of claim 9, wherein said pull-out work deck portion is slidably removable from said main work deck.

15. The aircraft galley of claim 9, further comprising at least one pull-out combination drain-sink drawer including at least one drain-sink.
